(19) United States
(12) Patent Application Publication
(10) Pub. No.: US 2026/0169702 A1
(43) Pub. Date: Jun. 18, 2026

(54) CANVAS ISSUE ORIENTATION ASSIST

(71) Applicant: SAP SE, Walldorf (DE)

(72) Inventors: Sandra SCHULZ, Schwetzingen (DE); Ekaterina SHPAK, Eppelheim (DE); Christopher ALLEN, Great Falls, VA (US)

(21) Appl. No.: 18/983,576

(22) Filed: Dec. 17, 2024

(51) Int. Cl. G06F 8/34

(52) U.S. Cl. CPC G06F 8/34

(57) ABSTRACT

Embodiments are described for a graphic-based programing system comprising a display, a memory, and at least one processor coupled to the display and the memory. The at least one processor is configured to receive a programing layout that comprises one or more function components and one or more connections between the one or more function components and store locations of the one or more function components in the memory. The at least one processor is further configured to determine that at least one function component out of the one or more function components corresponds to a first characteristic data and determine a working area in the programing layout. The at least one processor is further configured to determine that the at least one function component is outside the working area and display at least one indicator based on the location of the at least one function component.

### BACKGROUND

A graphic-based programing system, such as a canvas system, utilizes visible function components to create, design, and manage software applications. The graphic-based programing system provides an intuitive and accessible design experience for users. However, the users may be limited to viewing function components within a working area. Thus, it can be difficult to understand situations of and navigate to function components outside the working area.

### SUMMARY

Some embodiments of this disclosure relate to apparatus, system, computer program product, and method embodiments for implementing orientation assist in a graphic-based programing system.

Some embodiments of this disclosure provide a graphic-based programing system comprising a display, a memory, and at least one processor coupled to the display and the memory. The at least one processor is configured to receive a programing layout that comprises one or more function components and one or more connections between the one or more function components and store locations of the one or more function components in the memory. The at least one processor is further configured to determine that at least one function component out of the one or more function components corresponds to a first characteristic data and determine a working area in the programing layout. The at least one processor is further configured to determine that the at least one function component is outside the working area and display at least one indicator based on the location of the at least one function component.

Some embodiments of this disclosure provide a computer-implemented method for a graphic-based programing system. The method comprises receiving a programing layout that comprises one or more function components and one or more connections between the one or more function components and storing locations of the one or more function components in a memory of the graphic-based programing system. The method further comprises determining that at least one function component out of the one or more function components corresponds to a first characteristic data and determining a working area in the programing layout wherein the working area is associated with a size of a display of the graphic-based programing system and the working area is displayed on the display. The method further comprises determining that the at least one function component is outside the working area based on the location of the at least one function component and a location of the working area and displaying in the working area displayed on the display at least one indicator based on the location of the at least one function component.

Some embodiments of this disclosure provide a non-transitory computer-readable medium (CRM) comprising instructions to, upon execution of the instructions by one or more processors of a graphic-based programing system, cause the graphic-based programing system to perform operations. The operations comprise receiving a programing layout that comprises one or more function components and one or more connections between the one or more function components and storing locations of the one or more function components in a memory of the graphic-based programing system. The operations further comprise determining that at least one function component out of the one or more function components corresponds to a first characteristic data and determining a working area in the programing layout wherein the working area is associated with a size of a display of the graphic-based programing system and the working area is displayed on the display. The operations further comprise determining that the at least one function component is outside the working area based on the location of the at least one function component and a location of the working area and displaying in the working area displayed on the display at least one indicator based on the location of the at least one function component.

This Summary is provided merely for the purposes of illustrating some embodiments to provide an understanding of the subject matter described herein. Accordingly, the above-described features are merely examples and should not be construed to narrow the scope or spirit of the subject matter in this disclosure. Other features, embodiments, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example graphic-based programing system, according to some embodiments of the disclosure.

FIG. 2 illustrates a block diagram of an example graphic-based programing system, according to some embodiments of the disclosure.

FIG. 3 illustrates an example of a programming layout of the graphic-based programing system, according to some embodiments of the disclosure.

FIG. 4 illustrates an example method of indicating function components, according to some embodiments of the disclosure.

FIG. 5 illustrates an example method of determining whether a function component is outside a working area, according to embodiments of the disclosure.

FIG. 6 illustrates an example method of creating and showing indicators of function components, according to embodiments of the disclosure.

FIG. 7 illustrates an example of a display, according to some embodiments of the disclosure.

FIG. 8 illustrates an example computer system for implementing some embodiments of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments of this disclosure include apparatus, system, computer program product, and method embodiments for implementing orientation assist in a graphic-based programing system.

Graphic-based programing systems, such as a canvas system, replace or complement text-based code with function components that are visible, such as blocks, nodes, connections, and others. Users are enabled to create and/or manage programs by manipulating the function components and the connections therebetween. For example, a user can drag function components from a function pane onto a programing layout. The user can also connect the function components in the programming layout to define data flows from one function component to another. In such a way, the graphic-based programing systems provide a visual interface of the program being designed or edited that is intuitive to the user. The end program being designed in this environment can then be executed in a different environment for users and provide functionality in an area including, but not limited to, supply chain management, human resources, customer service, purchasing and sales, manufacturing control, factory control, etc.

In some embodiments, the user's view of the programing layout may be limited. For example, the graphic-based programing system may include or couple to a display, which can show the programing layout to the user. However, the display may be limited to show a portion of the programing layout at any given time because the display has a limited resolution or screen size (e.g., generally speaking smart phones have smaller display areas than laptop computers). The portion of the programing layout that is currently showing on a display device may be referred to as a working area or a viewport. Thus, the user's view of the programing layout is limited to what is shown in the working area as displayed on the display device. In some embodiments, the user can move the working area so that other portions of the programming layout can be shown to the user. In some embodiments, the working area can be large. For example, the programing layout may have a size that is ten times larger than a size of the working area. In such a case, it may be difficult for the user to move to certain function components because the user may not be able to remember where these function components are located or even that these function components exist. The user may need to move the working area around the programing layout to search for the function components. This process can be time-consuming and frustrating to the user. In addition, when the user is interested in multiple function components, the user may take even longer time to go through all the function components. Stated another way, if the user is working on one function component currently located in a working area and wants to get to another function component located outside of the working area, it can be difficult for the user to navigate to the other function component. Larger programming layouts and/or smaller display screens (e.g., screens on laptops or tablet computers) increase this navigational problem. In addition, complex programming layouts can also make it difficult to navigate within the programming layout as there will be many branches throughout the programming layout. Finally, being able to navigate from a current function component to a related function component can be more difficult as the size and complexity of the programming layout increases. Thus, an orientation assist tool is needed to help the user navigate in the programing layout.

In some embodiments, the graphic-based programing system can create and maintain indicators of function components of interest. An indicator is a graphical element shown in the working area that corresponds to one or more function components not currently shown in the working area of the programming layout. As an example, the graphic-based programing system may show the indicators in the working area regardless of where the working area moves relative to the full programming layout and relative to where the corresponding function component is outside of the working area. The indicators can indicate the function components with a combination of traits such as color, shape, text, and other properties of the indicators. In such a way, the user can identify the presence of corresponding function components by checking the indicators when those corresponding function components are not visible within the working area. Furthermore, the user can click on an indicator and the working area can move to a position of a function component within the programming layout corresponding to the indicator so that the user can then view and configure the function component in the working area. Because the indicators, when generated and maintained, are always showing in the working area, the user can navigate to the function components of interest without scrolling the working area around the programming layout to search for them. It should also be noted that if there is only one function component associated with one indicator, and that function component is made visible in the working area, any corresponding indicators to the visible function components would stop being displayed in the working area.

The indicators may be created or generated in a plurality of ways and include at least the following options. A first method is by user selection. As an example, a user may have a function component visible in the working area and associate an indicator to that function component by selecting an indicator from a working pane of the display (e.g., clicking via a mouse or touchpad or touching on a touchscreen) and then selecting a function component visible in the working area (e.g., via a clicking or touching action). Alternatively, the user may type commands into the appropriate area of the display device associating an indicator with a function component.

A second method of associating an indicator with a function component is automatically through the graphic-based programming system 102. In these instances, a user may be creating a function component and may enter an error or leave the function component incomplete. If before correcting or finishing the function component the user moves the working area so that this particular function component is no longer in the working area, the programming system will generate an indicator and associate it with that function component no longer visible in the working area.

Once generated, the indicators serve several functions. One purpose is to help the user scroll the working area toward the desired function component using an arrow of the indicator as a directional guide. Alternatively, the indicator may act as a shortcut operation where if the user selects an indicator visible in the working area, the programming system instructs the user device to adjust the working area such that the associated function component is visible in the working area. The first method allows the user to backtrack through the workflow at his or her own pace while the second method jumps the user to the function component in question.

In summary, the indicators in the working area enable the user to quickly move to function components and thus shorten the time required to create and/or manage a program using the graphic-based programing system.

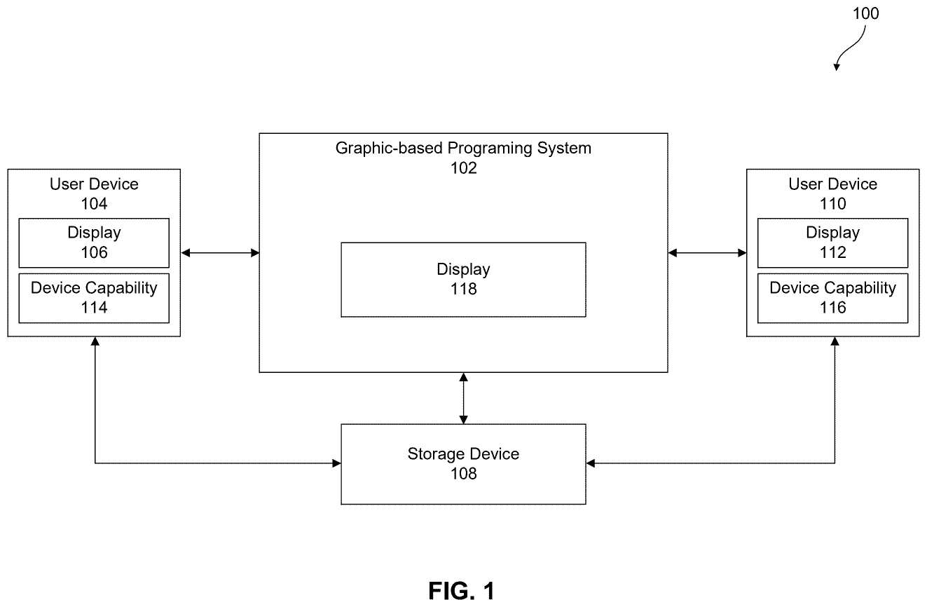

FIG. 1 illustrates an example graphic-based programing system, according to some embodiments of the disclosure. The example system 100 is provided for the purpose of illustration only and does not limit the disclosed embodiments. The example system 100 may include, but is not limited to, a graphic-based programing system 102, a user device 104, a user device 110, and a storage device 108. The user devices 104 and 110 may include their respective displays 106 and 112. In some embodiments, a first user may operate the user device 104 to make changes to a program layout. A second user may observe the changes using the user device 110. Furthermore, the user device 104 may include a device capability 114 and the user device 116 may include a device capability 116. In some embodiments, the graphic-based programing system 102 may include a display 118 that operates similarly as the displays 106 and 112 as discussed above and below. In some embodiments, the graphic-based programing system 102, the user device 104, the user device 110, and the storage device 108 may include, but is not limited to, computer systems, servers, cloud systems, cloud servers, laptops, desktops, personal computers, databases, user equipment, and the like. In some embodiments, the graphic-based programing system 102 and the storage device 108 can be integrated into a physical device so that functions of the graphic-based programing system 102 and the storage device 108 can be performed by the physical device. In some embodiments, the graphic-based programing system 102 and the storage device 108 can be different physical devices that are coupled together.

In some embodiments, the graphic-based programing system 102 receives instructions from the user device 104 to create, manage, and/or configure a program in a programing layout. The programing layout can be shown in the displays 106 and/or 112. The displays 106 and 112 may have a limited resolution or screen size. Thus the displays 106 and 112 may show a portion of the programing layout in a working area at any given time. The user device 104 can transmit instructions to the graphic-based programing system to move the working area in order to show other portions of the programing layout.

In some embodiments, the graphic-based programing system 102 can be configured to indicate one or more function components of the programing layout in the working area. For example, the graphic-based programing system 102 can determine that the one or more function components are of interest and are outside the working area. In such a case, the graphic-based programing system 102 can create one or more indicators in the working area that correspond to the one or more function components. In some embodiments, the one or more indicators may have traits such as different colors, shapes, and/or descriptions in text depending on the corresponding function components, reasons for providing an indicator to that function component (e.g., error, user tagged, etc.) or both. For example, the graphic-based programing system 102 can assign indicators with different traits such as a circle shape to function components that have errors and assign indicators with a square shape to function components that have warnings. For another example, the graphic-based programing system 102 can assign indicators in red to recently identified function components and assign indicators in green to function components identified more than a predetermined period ago. Thus, the one or more traits of an indicator may be associated with the type of the function component, the reason for associating an indicator with a particular function component or both. In some embodiments, the indicators can also include arrows. For example, the arrows can point to directions of the function components corresponding to the indicators. With the assistance of the one or more indicators, the users are informed of the existence and situation of the one or more function components.

In some embodiments, the users can also move the working area using the one or more indicators. For example, the graphic-based programing system 102 can store locations of the one or more function components in the storage device 108. When the users can click on one of the one or more indicators, the graphic-based programing system 102 can determine that a function component of the one or more function components corresponds to the one of one or more indicators. The graphic-based programing system 102 can then retrieve location information of the function component from the storage device 108 and moves the working area to a location of the function component. In this way, the users can move the working area to display function components indicated by the one or more indicators without needing to know where the function components locate.

In some embodiments, the first user can view the programing layout and use the one or more indicators to navigate to the one or more function components using the display 106 of the user device 104 instead of or in addition to the display 112. Thus, the second user can also view the programing layout and use the one or more indicators to navigate to the one or more function components using the display 112. In some embodiments, a size of the working area can be determined based on a resolution or screen size of the display 106, a resolution or screen size of the display 112, or both.

In some embodiments, the user device 104 may transmit parameters of the user device 104 to the graphic-based programing system 102. For example, the parameters may include the resolution of the display 106 or other information of the user device 104. The parameters may be stored in the device capability 114. Thus, the user device 104 may retrieve the parameters from the device capability 114 and transmit the parameters to the graphic-based programing system 102. In some embodiments, the graphic-based programing system 102 may transmit a part of or all of the programing layout to the user device 104. The user device 104 may then configure to show a portion of the programing layout on the display 106 based on the parameters retrieved from the device capability 114. For example, the user device 104 may retrieve the resolution of the display 106 from the capability 114 and display the portion of the programing layout on the display 106 based on the resolution. In some embodiments, the user device 110 may operate similarly as the user device 104.

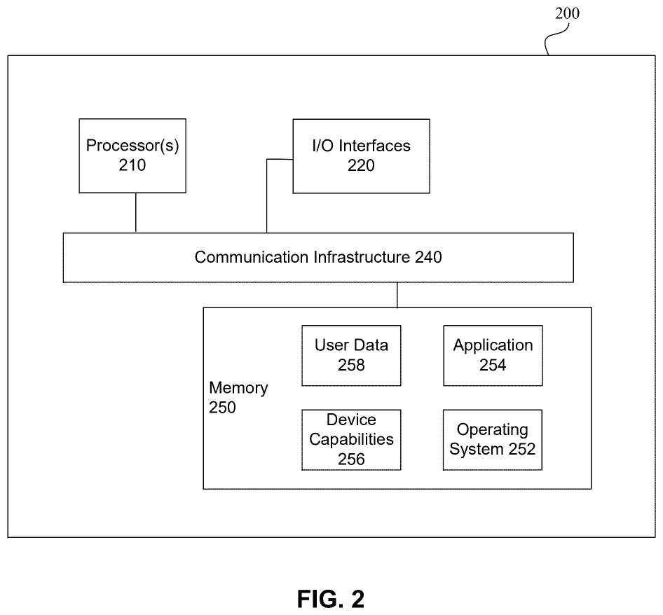

FIG. 2 illustrates a block diagram of an example graphic-based programing system, according to some embodiments of the disclosure. The electronic device 200 may be any of the electronic devices (e.g., the graphic-based programing system 102 of FIG. 1) of the system 100. The electronic device 200 includes a processor 210, one or more input/output (I/O) interfaces 220, a communication infrastructure 240, a memory 250, an operating system 252, an application 254, device capabilities 256, and user data 258. Illustrated systems are provided as exemplary parts of electronic device 200, and electronic device 200 may include other circuit(s) and subsystem(s). Also, although the systems of electronic device 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more I/O interfaces 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. One such application would be a graphics-based programming application to assist users in designing and editing program or application workflows. In some embodiments, the device capabilities 256 may be stored in the memory 250. Device capabilities 256 may include, but are limited to, screen sizes of various displays used in displaying and allowing users to interact with, programming workflows.

According to some examples, the user data 258 may be stored in the memory 250. The user data 258 may include data directed to users, such as programing flows. In some embodiments, the application 254 can create and/or manage programing flows for different users/tenants based on the user data 258.

The electronic device 200 may also include the communication infrastructure 240. The communication infrastructure 240 provides communication between, for example, the processor 210, the one or more I/O interfaces 220, and the memory 250. In some implementations, the communication infrastructure 240 may be a bus.

The processor 210, alone, or together with instructions stored in the memory 250 performs operations enabling electronic device 200 of the system 100 to implement mechanisms for the graphic-based programing system, as described herein. Alternatively, or additionally, the processor 210 can be “hard coded” to implement mechanisms for an orientation assist in a graphic-based programing system, as described herein.

The one or more I/O interfaces 220 transmit and receive communications signals support mechanisms for the orientation assist in a graphic-based programing system. Additionally, the one or more I/O interfaces 220 transmit and receive communications signals that support mechanisms for measuring communication link(s), generating and transmitting system information and data, and receiving the system information and data. According to some embodiments, the one or more I/O interfaces 220 may wirelessly transmit and receive the communication signals. In some embodiments, the one or more I/O interfaces 220 may be wired communication interferences, such as Ethernet, Universal Serial Bus (USB), serial port, serial advanced technology attachment (SATA), and fiber optic interferences. The one or more I/O interfaces 220 allow electronic device 200 to communicate with other devices that may be wired and/or wireless. In some examples, the one or more I/O interfaces 220 may include processors, controllers, radios, sockets, plugs, buffers, and like circuits/devices used for connecting to and communication on networks. According to some examples, the one or more I/O interfaces 220 include one or more circuits to connect to and communicate on wired and/or wireless networks.

According to some embodiments of this disclosure, the one or more I/O interfaces 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more I/O interfaces 220 may include more or fewer systems for communicating with other devices.

In some examples, the one or more the I/O interfaces 220 may include one or more circuits (including a WLAN transceiver) to enable connection(s) and communication over WLAN networks such as, but not limited to, networks based on standards described in IEEE 802.11.

Additionally, or alternatively, the one or more the I/O interfaces 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the one or more the I/O interfaces 220 may include a Bluetooth™ transceiver. Additionally, the one or more the I/O interfaces 220 may include one or more circuits (including a cellular transceiver) for connecting to and communicating on cellular networks.

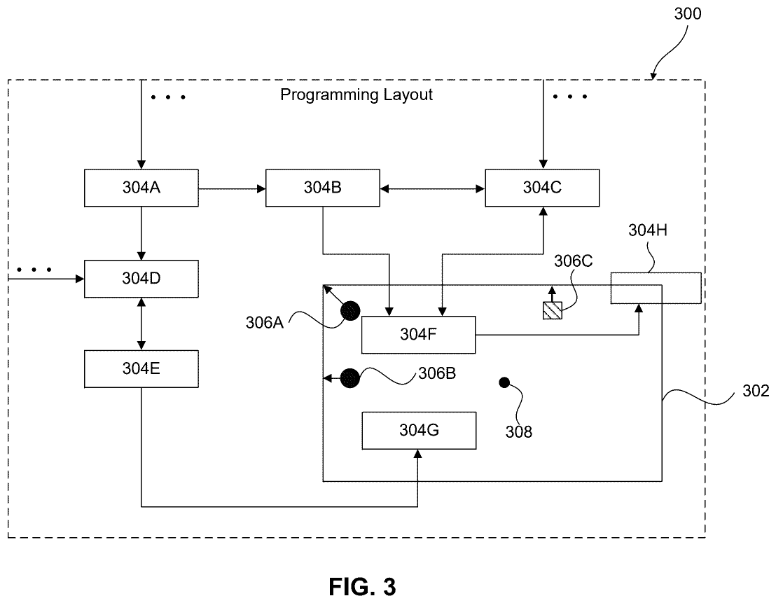

As discussed in more detail below with respect to FIGS. 3-7, processor 210 may implement different mechanisms for the orientation assist in a graphic-based programing system as discussed with respect to the system 100 of FIG. 1.

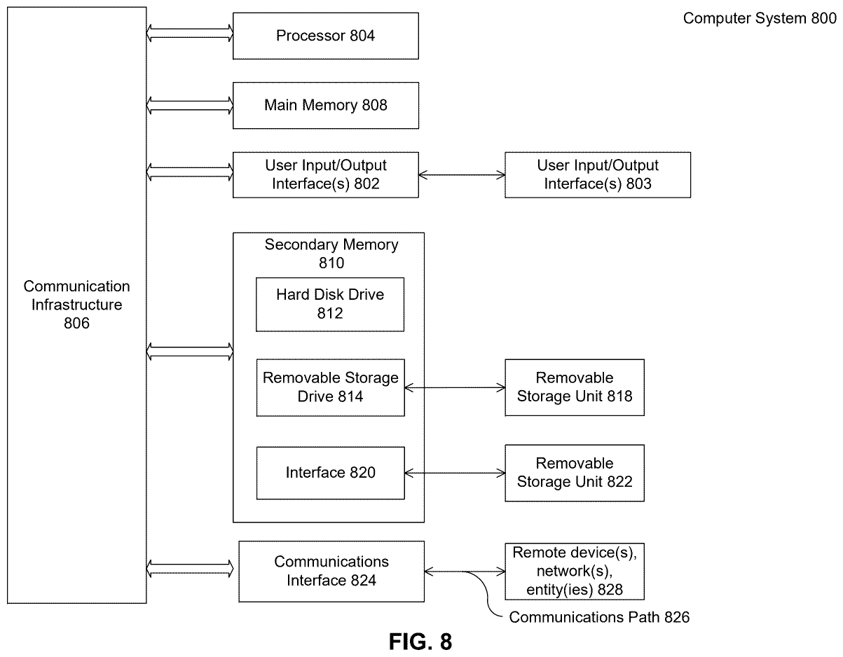

FIG. 3 illustrates an example of a programming layout 300 of the graphic-based programing system, according to some embodiments of the disclosure. As a convenience and not a limitation, FIG. 3 may be described with regard to elements of FIGS. 1, 2, and 8. The example of a programming layout 300 may represent the operation of devices (e.g., the graphic-based programing system 102, the user device 104, the user device 110, and the storage device 108, or a combination thereof of FIG. 1) implementing the orientation assist in a graphic-based programing system. The example of a programming layout 300 may also be performed by computer system 800 of FIG. 8. But the example of a programming layout 300 is not limited to the specific embodiments depicted in those figures and other systems may be used to perform the method, as will be understood by those skilled in the art. It is to be appreciated that not all operations may be needed, and the operations may not be performed in the same order as shown in FIG. 3.

In some embodiments, the programming layout 300 can include function components 304A, 304B, 304C, 304D, 304E, 304F, 304G, 304H. The function components can include preset functions or user-defined functions that can perform designed operations. For example, the function component 304A can be configured to read data from a database or receive data from another device. For another example, the function component 304G can be configured to output data in a display or to another device. In some embodiments, the function components can be connected. Specifically, connections between function components can represent data flows. For example, the function component 304B can be configured to process data. The function component 304B can receive the data from the function component 304A, represented by a connection between the function components 304A and 304B. The function component 304B can also transmit the processed data to the function component 304C, represented by a connection between the function components 304B and 304C. It should be noted that connections may be unidirectional (e.g., from function component 304A to function components 304B and/or 304D which is indicative of process flow going in only one direction) or bidirectional (e.g. between function component 304B and function component 304C). In addition, connections may be substantially straight and substantially linear with respect to their associated function components (e.g., the connection between function components 304A and 304D), include right angles (e.g., the connection between function components 304E and 304G) or be straight and inclined at an angle with respect to their associated function component (e.g., the connection from function component 304G to another not shown in FIG. 3). Finally, programming layout 300 is shown with only eight function components and eleven connections for the sake of clarity. Many more function components and connections therebetween may exist outside of the boundary represented by 300 as represented by the various ellipsis shown in FIG. 3.

In some embodiments, the programming layout 300 also includes a working area 302. The working area 302 may correspond to a display showing the programming layout 300 to a user, such as the display 106 or the display 112. As discussed above, a size of the working area 302 may depend on resolutions of one or more displays. For example, the display 106 and the display 112 may have a first resolution and a second resolution respectively. The use of two different displays at the same time can arise in a collaborative situation where two workers are remote from each other working on the same flow at the same time. To aid in this collaboration, it would be beneficial if both users saw the same working area as opposed to a situation where the user with the greater resolution or screen size sees more of the flow in his working area than the other worker with the smaller resolution or screen size. In such examples, both display devices 106 and 112 would be scaled such that both display the same contents of the working area even though they have different resolutions or screen sizes. Similarly, when a single user transitions between devices, such as handing over from a smaller device (e.g., mobile phone) to a larger device (e.g., stand-alone monitor at a home office), the working area on the larger device could remain the same as was on the smaller device or the system could enlarge the working area in line with use of the larger device. The size of the working area may correspond to the first resolution, the second resolution, the greater of the first and the second resolutions, or the smaller of the first and the second resolutions. In some embodiments, the function components of the programing layout 300 may be inside or outside the working area 302. For example, the function components 304A, 304B, 304C, 304D, and 304E (as well as other not shown in FIG. 3) are outside the working area 302. This means that the user may not be able to view or configure the function components 304A, 304B, 304C, 304D, and 304E, etc. because they are not shown in the working area 302. On the other hand, the function components 304F and 304G are inside the working area 302. Thus, the user may be able to view and configure the function components 304F and 304G in the working area 302. Furthermore, the function component 304H is partially inside the working area 302 and connected with the function component 304F with a unidirectional connection from the function component 304F to the function component 304H.

In some embodiments, the graphic-based programing system 102 may identify one or more function components that are of interest. The one or more function components may include, but not limited to, function components that have errors, have warnings, are outdated, require further configurations, have user interest, or are otherwise marked. For example, the function component 304C may require further configuration. Specifically, one or more parameters configured in the function component 304C may be temporary and subject to change. Thus, the function component 304C may have no error or warning, but still requires further configuration to finalize the temporary parameters.

For another example, the function component 304E may have errors or warnings. Specifically, the function component 304E may have a same name as the function component 304B. Since no duplicate names can be assigned in the programming layout 300, the graphic-based programing system 102 may issue an error or a warning in the function component 304E. Alternatively, the function component 304E may have an error or warning because one or more required parameters are not provided by the user. Thus, the graphic-based programing system 102 may issue an error or a warning since the function component 304E is incomplete.

For yet another example, the function component 304F can be marked by the user. The function component 304F may have no error or warning, but the user may want to re-check the function component 304F just to make sure that it is configured correctly and/or is consistent with other function components that are configured after the function component 304F. The user may mark the function component 304F for various reasons. For example, the function component 304F may be particularly important so its correctness is essential. For any reason or no reason at all, the user can mark the function component 304F by instructing the graphic-based programing system 102. For example, the user can transmit an instruction to the graphic-based programing system 102 via the user device 104 to mark the function component 304F. The instruction may indicate that the function component 304F is to be marked. In response, the graphic-based programing system 102 can identify the function component 304F as a function component of interest.

For yet another example, the function component 304D may include one or more parameters that are time-sensitive. For example, a parameter of the function component 304D may expire in two days. In such a case, the function component 304D may have no error or warning when the parameter was initially configured. However, after two days, the parameter may expire and the function component 304D may have an error or a warning due to the expired parameter. The graphic-based programing system 102 can identify the function component 304D as soon as the parameter is configured because it may expire before being updated. In such a case, the user can monitor the function component 304D so that the parameter can be reconfigured prior to expiration. However, this approach may draw unnecessary attention because the function component 304D is identified when the parameter is still valid. Alternatively, the graphic-based programing system 102 can identify the function component 304D after the parameter actually expires. In such a case, the user is not alerted of a potential issue with the expiring parameter and the function component 304D may become defective without being updated. The trade-off can be made between system resources and whether the defectiveness of the function component 304D is essential to the integrity of the operation of the programing layout 300.

In any case, the graphic-based programing system 102 can identify the one or more function components based on the reasons discussed above. The graphics-based programming system 102 may then store location information of the one or more function components. For example, the location information may include coordinates on the programming layout 300. A coordinate may include a horizontal axis index and a vertical axis index on the programing layout 300. The graphic-based programing system 102 may store the location information of the one or more function components in the storage device 108.

In addition, the graphic-based programing system 102 may store type information of the one or more function components in the storage device 108. For example, the graphic-based programing system 102 may store the type information and, as needed, at least one characteristic information or data together with the location information of the one or more function components in the storage device 108. In some embodiments, the type information may indicate functions performed by the one or more function components. For example, the type information of the function component 304D may indicate that the function component 304D processes data received from other function components. Furthermore, the characteristic data, when associated with a function component, may indicate a reason that a function component is identified. For example, the characteristic data when associated with the function component 304D may indicate that the function component 304D may have errors in the future (when the graphic-based programing system 102 identifies a function component as soon as a time-sensitive parameter is configured) or that the function component 304D has an error (when the graphic-based programing system 102 identifies a function component after a time-sensitive parameter actually expires). For another example, the characteristic data of the function component 304C may indicate that the function component 304C requires further configuration. Characteristic data may also be generated by a user of the system who designates a particular function component as being of interest. The composition of an indicator may therefore be based on the type of associated function component, the reason for tagging that function component, or a combination of both.

In some embodiments, the graphic-based programing system 102 may determine whether the one or more function components identified are outside the working area. The graphic-based programing system 102 can first retrieve the location information of the one or more function components and compare locations of the one or more function components with boundaries of the working area. In some embodiments, the graphic-based programing system 102 may determine the boundaries of the working area 302 based on a center location of the working area 302 and display size and/or resolutions. For example, the graphic-based programing system 102 may determine that the center location of the working area 302 has a coordinate (X, Y). In other words, a horizontal axis index and a vertical axis index of the center location of the working area 302 are X and Y respectively. For explanation purposes only, a circle 308 shown on the center location inside working area 302 is shown in FIG. 3 but would not necessarily be displayed on a display device to the end user. The graphic-based programing system 102 may further determine that the size of the working area 302 is A×B. As discussed above, the size of the working area 302 can be determined based one or more display sizes and/or resolutions. For example, if the working area 302 is to be displayed in the display 106, which has a resolution of A×B, the graphic-based programing system 102 may determine that the size of the working area 302 is A×B. For another example, if the working area 302 is to be displayed in the display 106 and the display 112 with resolutions of A×B and C×D respectively. The graphic-based programing system 102 may determine that A×B is smaller than C×D and thus the size of the working area 302 is C×D. In any case, the graphic-based programing system 102 then determines the boundaries of the working area. For example, assuming that the coordinate of the center location of the working area 302 is (X, Y) and the size of the working area 302 is A×B, the graphic-based programing system 102 may determine that horizontal boundaries of the working area 302 are between X−A/2 and X+A/2 and vertical boundaries of the working area 302 are between Y−B/2 and Y+B/2. In some embodiments, the graphic-based programing system 102 determines that a function component is outside the working area 302 if a horizontal axis index of the function component is outside the horizontal boundaries or if a vertical axis index of the function component is outside the vertical boundaries. For example, the graphic-based programing system 102 may identify the function components 304C, 304D, 304E, and 304F as discussed above. The graphic-based programing system 102 may further determine that the function components 304C, 304D, and 304E are outside the working area 302 because the function component 304C is outside the vertical boundaries, the function component 304E is outside the horizontal boundaries, and the function component 304D is outside both the vertical and horizontal boundaries. The graphic-based programing system 102 may also determine that the function component 304F is inside the working area 302 because the function component 304F is inside both the vertical boundaries and the horizontal boundaries.

In some embodiments, the graphic-based programing system 102 may indicate function components that are identified and are outside the working area 302 using indicators. For example, the graphic-based programing system 102 may indicate the function components 304C, 304D, and 304E using indicators 306C, 306A, and 306B respectively. In some embodiments, the graphic-based programing system 102 may assign certain traits such as shapes and colors to indicators based on corresponding function components. For example, the graphic-based programing system 102 may assign shapes to indicators based on functions performed by the corresponding function components. Specifically, the function component 304C may give labels to data, but function components 304D and 304E process data. The graphic-based programing system 102 may assign the square shape to labeling function components and thus the indicator 306C is a square. Additionally, the graphic-based programing system 102 may assign the circle shape to processing function components and thus the indicators 306A and 306B are circles.

For another example, the graphic-based programing system 102 may assign shapes to indicators based on reasons that the corresponding function components are identified. As discussed above, the function component 304C may be identified because it requires further configuration and function components 304D and 304E may be identified because they either have errors currently or may have errors in the future. The graphic-based programing system 102 may assign the square shape to indicators corresponding to function components that require further configurations and thus the indicator 306C is a square. Additionally, the graphic-based programing system 102 may assign the circle shape to indicators corresponding to function components related to errors and thus the indicators 306A and 306B are circles. In some embodiments, the indicators may change over time. For example, if the graphic-based programing system 102 identifies function components after errors actually occur, the graphic-based programing system 102 may identify the function component 304D after the time-sensitive parameter actually expires. Thus, the indicator 306A may not exist when the time-sensitive parameter of the function component 304D is initially configured and still valid. However, after a predetermined time period passes, such as two days later, the time-sensitive parameter may expire and the graphic-based programing system 102 may indicate the function component 304D using the indicator 306A in the working area 302. In addition, the user may reconfigure the time-sensitive parameter after it expires, which makes the time-sensitive parameter unexpired again. In such a case, the graphic-based programing system 102 may remove the indicator 306A from the working area since the function component 304D no longer has errors.

In some embodiments, similar to assigning shapes, the graphic-based programing system 102 may assign other traits such as colors to indicators based on functions performed by the corresponding function components and/or reasons that the corresponding function components are identified. For example, the graphic-based programing system 102 may assign yellow to the indicator 306C and may assign red to the indicators 306A and 306B similar to the discussion above. In some embodiments, the graphic-based programing system 102 may change a traits, such as a color(s), of indicators as time passes. For example, the graphic-based programing system 102 may assign green to an indicator when the indicator is created. After a first period of time, such as couple of hours, the graphic-based programing system 102 may change the color of the indicator to yellow. After a second period of time, such as couple of days, the graphic-based programing system 102 may change the color of the indicator to red. This approach may distinguish levels of urgency for different indictors. For example, function components that have errors for a longer time may need more attention compared with function components that have errors for a shorter time period.

In some embodiments, the indicators, such as the indicators 306A, 306B, and 306C, may include arrows pointing to corresponding function components. The graphic-based programing system 102 may determine directions of the arrows based on locations of the indicators within the working area 302 and locations of corresponding function components. For example, the arrow of the indicator 306A has a direction pointing from a location of the indicator 306A within working area 302 to the location of the function component 304D. It should be noted that the direction of an arrow of indicator may be parallel, perpendicular or oblique to any connection displayed in the working area 302.

In some embodiments, the graphic-based programing system 102 may determine locations of indictors based on the center location of the working area 302 and locations of the function components. Specifically, the graphic-based programing system 102 may place indicators along top, bottom, left, or right boundaries of the working area 302. For example, as shown in FIG. 3, the graphic-based programing system 102 may place the indicator 306C along the top boundary of the working area 302 and may place the indicators 306A and 306B along the left boundary of the working area 302. Specifically, the center of the working area 302 may have a coordinate (X, Y) and a location of a function component may have a coordinate (X′, Y′). The graphic-based programing system 102 first determines a

$$slope = \frac{{X}^{′} - X}{{Y}^{′} - Y} .$$

The graphic-based programing system 102 may place the indicator along the right boundary if-1≤K≤1 and X′≥X. The graphic-based programing system 102 may place the indicator along the left boundary if −1≤K≤1 and X′≤X. The graphic-based programing system 102 may place the indicator along the top boundary if {K>1 or K<−1} and Y′>Y. The graphic-based programing system 102 may place the indicator along the top boundary if {K>1 or K<−1} and Y′<Y. In some embodiments, the graphic-based programing system 102 may determine the directions of arrows of the indicators based on the locations of the indicator. Specifically, an arrow of an indicator points to a boundary that the indicator locates. For example, the graphic-based programing system 102 may determine that the arrows of the indicator 306B points to the left because the indicator 306B is located along the left boundary. For another example, the graphic-based programing system 102 may determine that the arrow of the indicator 306C points to the top because the indicator 306C is located along the top boundary. Similarly, the graphics-based programming system 102 may determine that the arrow of the indicator 306A points at an angle or through a corner of working area 302 because it is placed near the upper-left corner of working area 302.

In some embodiments, the user can click on an indicator and the working area can move to the location of a function component corresponding to the indicator. For example, the user may click on the indicator 306C. The graphic-based programing system 102 may move the working area 302 to a location within the programming layout such that function component 304C is visible at or near the center of the relocated working area 302. Specifically, the function component 304C may have a center coordinate (A, B). In such a case, the graphic-based programing system 102 may move the working area 302 so that the center location of the working area 302 also has the center coordinate (A, B). In other words, the function component 304C becomes the center of the working area 302. It should be noted that the direction of an indicator may not necessarily coincide with the direction of a connection shown in the working area 302. In addition, the indicator may point to a function component that is several function components upstream or downstream of the portion of the flow shown in working area 302. Finally, the location of an indicator can move as the working area 302 is scrolled or jumped through and around the programming layout flow. As an example, FIG. 3 shows indicator 306C generally pointing upwards. If the user were to move the working area 302 upwards (e.g., a scrolling action), function component 304C would eventually become visible in the working area 302 and thus indicator 306C may cease to be displayed in the working area 302. However, if the user continues to move working area 302 further up the programming layout flow such that working area 302 were above function component 304C, indicator 306C would again be displayed in working area 302, but its new location would be at the bottom of working area 302 and it would be pointing generally downward towards function component 304C.

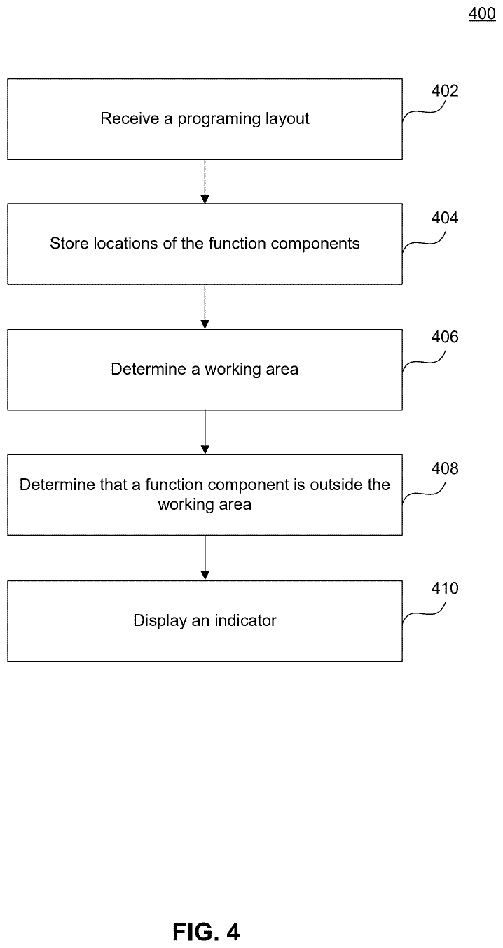

FIG. 4 illustrates an example method 400 of indicating function components, according to some embodiments of the disclosure. As a convenience and not a limitation, FIG. 4 may be described with regard to elements of FIGS. 1, 2, and 8. The example method 400 may represent the operation of devices (e.g., the graphic-based programing system 102, the user device 104, the user device 110, and the storage device 108, or a combination thereof of FIG. 1) implementing the orientation assist in a graphic-based programing system. The example method 400 may also be performed by computer system 800 of FIG. 8. But the example method 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4.

At 402, a graphic-based programing system, such as the graphic-based programing system 102, receives a programing layout, such as the programing layout 300. In some embodiments, the programing layout comprise one or more function components and one or more connections between the one or more function components. The graphic-based programing system may identify the one or more function components because they have errors, have warnings, require further configurations, are marked by a user of the graphic-based programing system, or for other reasons.

At 404, the graphic-based programing system stores locations of the one or more function components in a memory, such as the memory device 108. In some embodiments, the locations may include coordinates that comprise horizontal axis indexes and vertical axis indexes of the one or more function components. In some embodiments, the graphic-based programing system may also store type information and characteristic data of the one or more function components. For example, the type information may indicate function types of the one or more function components and the characteristic data may indicate the reasons that the one or more function components are identified. In some embodiments, the graphic-based programing system may determine that at least one function component out of the one or more function components corresponds to a first characteristic data. The first characteristic data may indicate that the at least one function component has errors, has warnings, requires further configurations, is marked by a user of the graphic-based programing system, or for other reasons. In some embodiments, the graphic-based programing system may generate the first characteristic data based on one or more instructions from a user of the graphic-based programing system. The graphic-based programing system may also generate the first characteristic data when at least one error is detected in the at least one function component.

At 406, the graphic-based programing system determines a working area in the programing layout, such as the working area 302. For example, the graphic-based programing system may determine a center location and a size of the working area. The size of the working area may correspond to sizes and/or resolutions of one or more displays, such as the display 106 and the display 112, as discussed above in FIG. 3.

At 408, the graphic-based programing system determines that the at least one function component is outside the working area. In some embodiments, the graphic-based programing system may determine boundaries of the working area. For example, the graphic-based programing system may determine the boundaries of the working area based on the center location and the size of the working area with respect to the display size and space of the display size allocated to the working area. The graphic-based programing system may then determine whether the at least one function component is outside the working area based on the locations of the at least one function component and the boundaries of the working area.

At 410, the graphic-based programing system displays in the working area displayed on the display at least one indicator based on the location of the at least one function component. As discussed above, the at least one indicator may have various traits that include shapes, colors, and/or arrows depending on the one or more function components that correspond to the one or more indicators.

In some embodiments, the graphic-based programing system may further determine that the at least one function component is of a first type. The graphic-based programing system may then determine a first trait based on the first type and display the at least one indicator using the first trait. In some embodiments, the first trait can be a shape and/or a color.

In some embodiments, the graphic-based programing system may receive an instruction to associate a characteristic to the at least one function component. For example, the graphic-based programing system may receive the instruction from a user device or a user of the graphic-based programming system. The graphic-based programing system may further determine a first trait based on the characteristic and display the at least one indicator using the first trait.

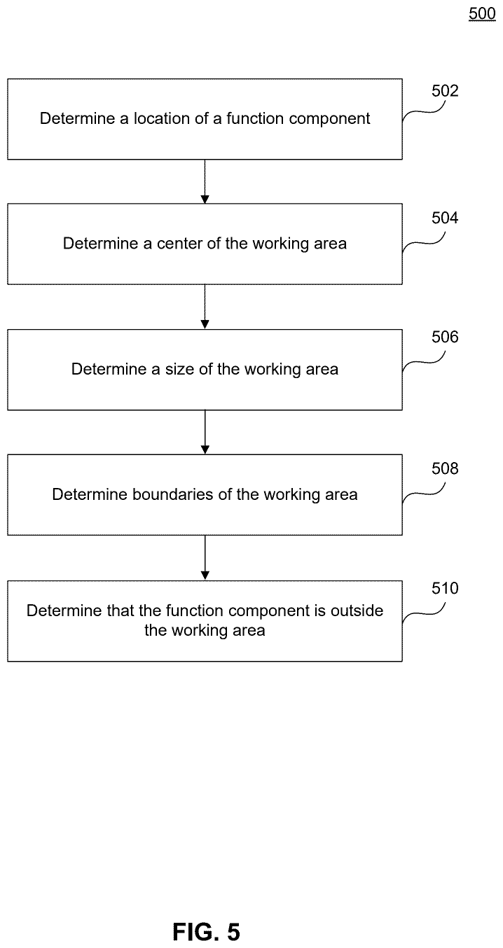

FIG. 5 illustrates an example method 500 of determining whether a function component is outside a working area, according to embodiments of the disclosure. As a convenience and not a limitation, FIG. 5 may be described with regard to elements of FIGS. 1, 2, and 8. The example method 500 may represent the operation of devices (e.g., the graphic-based programing system 102, the user device 104, the user device 110, and the storage device 108, or a combination thereof of FIG. 1) implementing the orientation assist in a graphic-based programing system. The example method 500 may also be performed by computer system 800 of FIG. 8. But the example method 500 is not limited to the specific embodiments depicted in those figures and other systems may be used to perform the method, as will be understood by those skilled in the art. It is to be appreciated that not all operations may be needed, and the operations may not be performed in the same order as shown in FIG. 5.

At 502, a graphic-based programing system, such as the graphic-based programing system 102, determines a location of a function component. In some embodiments, the graphic-based programing system may retrieve location information from a memory device, such as the memory device 108. The location information may include a coordinate of the function component, which includes a first horizontal axis index and a first vertical axis index. In some embodiments, the coordinate of the function component are measured within a programing layout of the graphic-based programing system, such as the programming layout 300.

At 504, the graphic-based programing system determines a center location of the working area. In some embodiments, the center locations include a coordinate of the center of the working area, which includes a second horizontal axis index and a second vertical axis index. Similar to the coordinate of the function component, the coordinate of the center of the working area is also measured within the programing layout of the graphic-based programing system, such as the programming layout 300.

At 506, the graphic-based programing system determines a size of the working area. In some embodiments, the graphic-based programing may determine the size of the working area based on a display coupled to or included in the graphic-based programing system. For example, the graphic-based programing system may be couple to or include a display, such as the display 106. The graphic-based programing system may determine that a resolution of the display is A×B. In some embodiments, the graphic-based programing system may determine that the size of the working area is also A×B. In other embodiments, the graphic-based programing system may determine that the size of the working area is a scaled version of A×B, such as nA×nB, wherein n is a factor that can be smaller than 1. Thus, the working area can be a shrunk so as to require a portion of the display.

In some embodiments, the graphic-based programing system may be coupled to multiple displays, such as the display 106 and the display 110. In some embodiments, the graphic-based programing system may determine the size of the working area based the resolution of one of the multiple displays. For example, the graphic-based programing system can determine that the display 106 is used more often than the display 110 or that the display 106 is a default display. In either case, the graphic-based programing system may determine the size of the working area based on the resolution of the display 106. In some embodiments, the graphic-based programing system may determine the size of the working area based on resolutions of both the display 106 and the display 112. For example, the graphic-based programing system may determine an overall resolution based on the display 106 and the display 112. The graphic-based programing system may then determine the size of the working area based on the overall resolution. For example, the graphic-based programing system may determine the overall resolution based on the greater of or the smaller of the display 106 and the display 112. For another example, the graphic-based programing system may determine the overall resolution based portions of the display 106 and the display 112. Specifically, the overall resolution may be a sum of a first scaler times the resolution of the display 106 plus a second scaler times the resolution of the display 112. The first scaler and the second scaler are positive fraction numbers with a sum of one. In some embodiments, the graphic-based programing system can determine the first scaler and the second scaler based on frequencies of use or user priorities of the display 106 and the display 112.

At 508, the graphic-based programing system determines boundaries of the working area. In some embodiments, the graphic-based programing system determines boundaries based on the center location and the size of the working area, as discussed above in FIG. 3.

At 510, the graphic-based programing system determines that the function component is outside the working area based on the determination that the location of the function component is outside the boundaries. For example, the graphic-based programing system may determine that the function component is outside the working area if a horizontal axis index of the function component is outside horizontal boundaries of the working area or if a vertical axis index of the function component is outside vertical boundaries of the working area, as discussed above in FIG. 3.

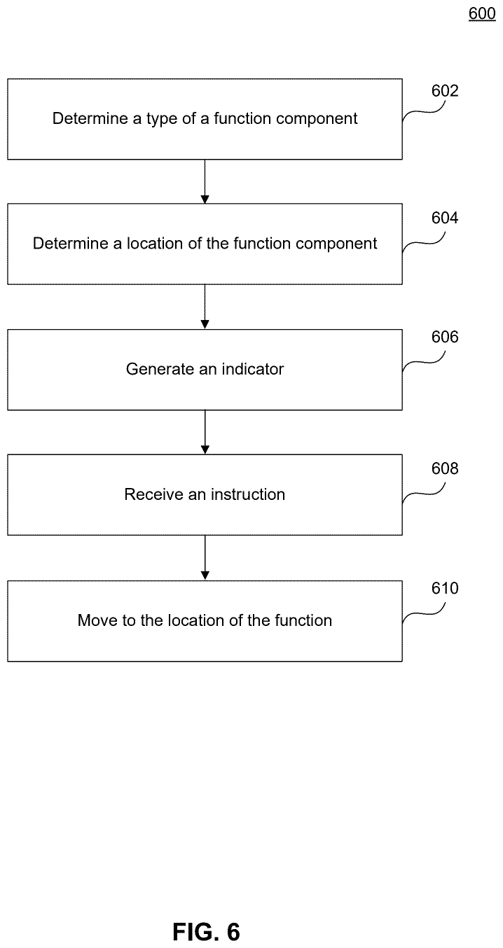

FIG. 6 illustrates an example method 600 of creating and showing indicators of function components, according to embodiments of the disclosure. As a convenience and not a limitation, FIG. 6 may be described with regard to elements of FIGS. 1, 2, and 8. The example method 600 may represent the operation of devices (e.g., the graphic-based programing system 102, the user device 104, the user device 112, and the storage device 108, or a combination thereof of FIG. 1) implementing the orientation assist in a graphic-based programing system. The example method 600 may also be performed by computer system 800 of FIG. 8. But the example method 600 is not limited to the specific embodiments depicted in those figures and other systems may be used to perform the method, as will be understood by those skilled in the art. It is to be appreciated that not all operations may be needed, and the operations may not be performed in the same order as shown in FIG. 6.

At 602, a graphic-based programing system, such as the graphic-based programing system 102, determines that a function component is of a first type. In some embodiments, the first type may indicate a function performed by the function component. For example, the function may be processing data, retrieving data, outputting data, adding labels to data, and so on. In addition, any associated characteristic data indicate a reason that the function component is identified by the graphic-based programing system. For example, the graphic-based programing system may identify the function component because the function component includes errors, warnings, needs to be further configured, or otherwise is marked by a user of the graphic-based programing system.

At 604, the graphic-based programing system determines a location of the function component. In some embodiments, the location of the function component includes a coordinate of the function component, as discussed above in FIGS. 3 and 5.

At 606, the graphic-based programing system generates an indicator of the function component. In some embodiments, the indicator has one or more traits such as a shape, a color, and/or an arrowing pointing to the function component as discussed above in FIG. 3. The graphic-based programing system displays the indicator within a working area, such as the working area 302.

At 608, the graphic-based programing system receives an instruction from a user of the graphic-based programing system. In some embodiments, the instruction can be a click on the indicator or other types of instructions to activate the indicator. The graphic-based programing system may receive the instruction from a user device, such as the user device 104. The graphic-based programing system may also receive the instruction from a display coupled to the graphic-based programing system, such as the display 106. For example, the user may click on the function component on a screen of the display 106.

At 610, the graphic-based programing system moves the working area to the location of the function component. In some embodiments, the graphic-based programing system may change a center location of the working area to be the location of the function component. For example, the center location of the working area may include a coordinate (X, Y) and the location of the function component may include a coordinate (A, B). In such a case, the graphic-based programing system may change the coordinate of the center location to be (A, B).

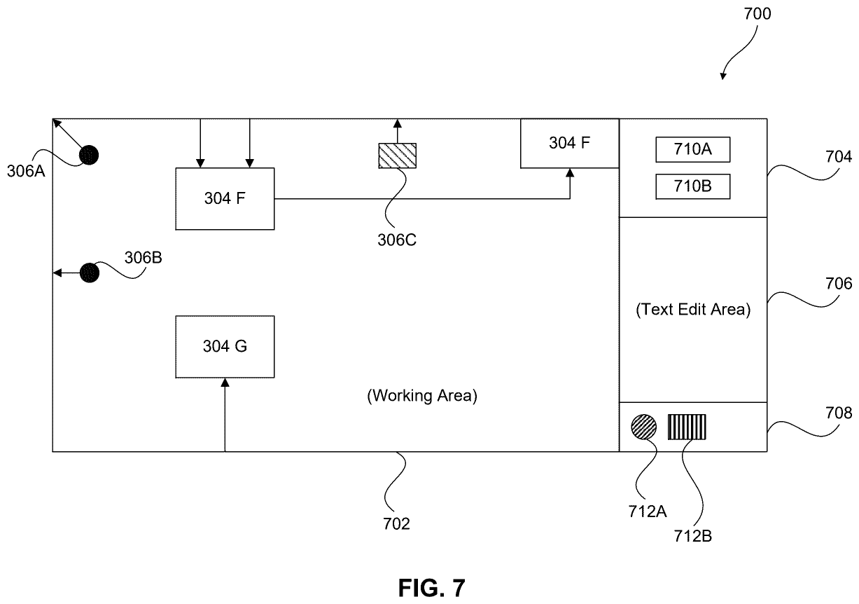

FIG. 7 illustrates an example 700 of a display, according to some embodiments of the disclosure. As a convenience and not a limitation, FIG. 7 may be described with regard to elements of FIGS. 1, 2, and 8. The example 700 of a display may represent the operation of devices (e.g., the graphic-based programing system 102, the user device 104, and the user device 110, or a combination thereof of FIG. 1) implementing the orientation assist in a graphic-based programing system. The example 700 may also be performed by computer system 800 of FIG. 8. But the example of a programming layout 800 is not limited to the specific embodiments depicted in those figures and other systems may be used to perform the method, as will be understood by those skilled in the art. It is to be appreciated that not all operations may be needed, and the operations may not be performed in the same order as shown in FIG. 8.

In some embodiments, the example 700 illustrates content being shown on a display, such as the displays 106, 112, and 118 in FIG. 1. The example 700 includes a working area 702, a functional component area 704, a text editing area 706, and an indicator area 708. In some embodiments, the working area 702 can be a portion of the display that shows content in a working area, such as the working area 302 in FIG. 3. For example, the working area 702 can show the functional components 304F, 304G, and a portion of the functional components 304H. The working area 702 can also show connections among the functional components inside the working area 702 and connections to functional components outside the working area 702. Finally, the working area 702 can show the indicators 306A, 306B, and 306C. In some embodiments, a user can move the working area 702 to a different position by clicking and dragging a point on the working area 702.

In some embodiments, the functional component area 704 may include functional components that the user can use to build a programing layout, such as the programing layout 300. For example, the functional component area 704 may include functional components 710A and 710B. The user may click and drag the functional components 710A and 710B into the working area 702.

In some embodiments, the text editing area 706 may include a text area that the user can use to edit functional components. For example, the user can use the text editing area 706 to fix errors in a functional component.

In some embodiments, the indicator area 708 may include indicators that the user can use to indicate functional components as discussed above. For example, the indicator area 708 may include indicators 712A and 712B. The user can click and drag indicators in the indicator area 708 into the working area 702. Once an indicator is in the working area, the user can associate a functional component in the working area with the indicator by clicking both. In some embodiments, the user can associate the functional component with the indicator without dragging the indicator to the working area 702. For example, the user can click the functional component in the working area 702 first and subsequently click the indicator in the indicator area 702.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802. As an example, a user may use one input/output device (e.g., 802 as a keyboard, touchpad, mouse, touchscreen, etc.) to type in text, drag and drop or otherwise add or delete elements (e.g., function components or connections therebetween) or otherwise navigate the working area around the programming layout with respect to a program that is concurrently displayed on a display (e.g., 803).

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc. Processor 804 may be used to both scale the relative sizes of function components and connectors from the programming layout into the working area as well as provide directional guidance (e.g., generate a vector from the placement of the indicator in the working area to its associated function component and thus provide a direction as to where the indicator should point) towards a non-displayed function component from a position within the working area.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A graphic-based programing system, comprising:
a display;
a memory; and
at least one processor coupled to the display and the memory and configured to:
receive a programing layout that comprises one or more function components and one or more connections between the one or more function components;
store locations of the one or more function components in the memory;
determine that at least one function component corresponds to a first characteristic data;
determine a working area in the programing layout wherein the working area is associated with a size of the display and the working area is displayed on the display;
determine that the at least one function component is outside the working area based on the location of the at least one function component and a location of the working area; and
display in the working area displayed on the display at least one indicator based on the location of the at least one function component.

2. The graphic-based programing system of claim 1, wherein the first characteristic data is generated based one or more instructions from a user of the graphic-based programing system.

3. The graphics-based programming system of claim 1 wherein the first characteristic data is generated when at least one error is detected in the at least one function component.

4. The graphic-based programing system of claim 1, wherein the at least one processor is further configured to:
determine that the at least one function component is of a first type;
determine a first trait based on the first type; and
wherein the at least one indicator is displayed using the first trait.

5. The graphic-based programming system of claim 4, wherein the first trait is a shape.

6. The graphic-based programming system of claim 4, wherein the first trait is a color.

7. The graphic-based programming system of claim 1, wherein the at least one processor is further configured to:
receive an instruction to associate a characteristic to the at least one function component;
determine a first trait based on the characteristic; and
wherein the at least one indicator is displayed using the first trait.

8. The graphic-based programming system of claim 7, wherein the instruction is received from a user device.

9. The graphic-based programming system of claim 7, wherein the received instruction is received from a user of the graphic-based programming system.

10. The graphic-based programing system of claim 1, wherein the at least one processor is further configured to:
determine a direction from the working area to the at least one function component,
wherein the at least one indicator includes an arrow pointing in the direction.

11. The graphic-based programing system of claim 1, wherein the at least one processor is further configured to:
receive an instruction to move to the at least one function component; and
move the working area to the location of the at least one function component.

12. The graphic-based programing system of claim 11, wherein the instruction includes a click on an indicator of the first function component.

13. A computer-implemented method for a graphic-based programing system, comprising:
receiving a programing layout that comprises one or more function components and one or more connections between the one or more function components;
storing locations of the one or more function components in a memory of the graphic-based programing system;
determining that at least one function component out of the one or more function components corresponds to a first characteristic data;
determining a working area in the programing layout wherein the working area is associated with a size of a display of the graphic-based programing system and the working area is displayed on the display;
determining that the at least one function component is outside the working area based on the location of the at least one function component and a location of the working area; and
displaying in the working area displayed on the display at least one indicator based on the location of the at least one function component.

14. The computer-implemented method of claim 13, wherein the first characteristic data is generated based one or more instructions from a user of the graphic-based programing system or when at least one error is detected in the at least one function component.

15. The computer-implemented method of claim 13, further comprising:
determining that the at least one function component is of a first type;
determining a first trait based on the first type; and
wherein the at least one indicator is displayed using the first trait.

16. The computer-implemented method of claim 13, further comprising:
determining a direction from the working area to the at least one function component, wherein the at least one indicator includes an arrow pointing in the direction;
receiving an instruction to move to the at least one function component; and
moving the working area to the location of the at least one function component.

17. A non-transitory computer-readable medium (CRM) comprising instructions to, upon execution of the instructions by one or more processors of a graphic-based programing system, cause the graphic-based programing system to perform operations, the operations comprising:
receiving a programing layout that comprises one or more function components and one or more connections between the one or more function components;
storing locations of the one or more function components in a memory of the graphic-based programing system;
determining that at least one function component out of the one or more function components corresponds to a first characteristic data;
determining a working area in the programing layout wherein the working area is associated with a size of a display of the graphic-based programing system and the working area is displayed on the display;
determining that the at least one function component is outside the working area based on the location of the at least one function component and a location of the working area; and
displaying in the working area displayed on the display at least one indicator based on the location of the at least one function component.

18. The non-transitory CRM of claim 17, wherein the first characteristic data is generated based one or more instructions from a user of the graphic-based programing system or when at least one error is detected in the at least one function component.

19. The non-transitory CRM of claim 17, wherein the operations further comprise:
determining that the at least one function component is of a first type;
determining a first trait based on the first type; and
wherein the at least one indicator is displayed using the first trait.

20. The non-transitory CRM of claim 17, wherein the operations further comprise:
determining a direction from the working area to the at least one function component, wherein the at least one indicator includes an arrow pointing in the direction;
receiving an instruction to move to the at least one function component; and
moving the working area to the location of the at least one function component.
